(19) United States
(12) Patent Application Publication
(10) Pub. No.: US 2025/0209426 A1
(43) Pub. Date: Jun. 26, 2025

(54) TASK MANAGEMENT METHODS AND SYSTEMS

(71) Applicant: HANSONG (NANJING) TECHNOLOGY LTD., Nanjing (CN)

(72) Inventors: Mengling KE, Nanjing (CN); Yang CHEN, Nanjing (CN); Bin ZHOU, Nanjing (CN); Boshen YAN, Nanjing (CN); Yingbo PAN, Nanjing (CN); Yue XU, Nanjing (CN); Wei CHEN, Nanjing (CN)

(73) Assignee: HANSONG (NANJING) TECHNOLOGY LTD., Nanjing (CN)

(21) Appl. No.: 19/078,316

(22) Filed: Mar. 13, 2025

Related U.S. Application Data
(63) Continuation of application No. PCT/CN2023/119018, filed on Sep. 15, 2023.

(30) Foreign Application Priority Data
Sep. 16, 2022 (CN) 202211127634.4

(51) Int. Cl. G06Q 10/1093; G06F 3/04815; G06F 3/04845; G06F 3/04847

(52) U.S. Cl. CPC G06Q 10/1097; G06F 3/04815; G06F 3/04845; G06F 3/04847; G06F 2203/04804

(57) ABSTRACT

The present disclosure relates to task management methods and systems. The methods include displaying a three-dimensional coordinate system, dimensions of the three-dimensional coordinate system corresponding one-to-one to parameter types of a task. The methods include determining or updating parameter values of the task based on a first input from a user, the parameter values corresponding one-to-one to the parameter types. The methods further include displaying the task in the three-dimensional coordinate system through a stereo graphic based on the parameter values of the task, a position of the stereo graphic in the three-dimensional coordinate system being correlated with the parameter values.

### CROSS REFERENCE TO RELATED APPLICATIONS

The present disclosure is a continuation of International Patent Application No. PCT/CN2023/119018, filed on Sep. 15, 2023, which claims priority to Chinese application No. 202211127634.4, filed on Sep. 16, 2022, the entire contents of each of which are incorporated herein by reference.

### TECHNICAL FIELD

The present disclosure relates to the field of information management technology, and in particular, to task management methods and systems.

### BACKGROUND

With the increasing number of tasks in people's daily lives, pre-setting task has become an important way to help people record detailed task information, which can assist users in planning their schedules and serve as a reminder for corresponding task arrangements.

Therefore, it is desired to provide task management methods and systems that are more user-friendly, enabling users to quickly access task-related information, thereby enhancing the user experience.

### SUMMARY

One of the embodiments of the present disclosure provides a task management method. The task management method may include displaying a three-dimensional coordinate system. Dimensions of the three-dimensional coordinate system may correspond one-to-one to parameter types of a task. The task management method may include determining or updating parameter values of the task based on a first input from a user. The parameter values may correspond one-to-one to the parameter types. The task management method further may include displaying the task in the three-dimensional coordinate system through a stereo graphic based on the parameter values of the task. A position of the stereo graphic in the three-dimensional coordinate system may be correlated with the parameter values.

One of the embodiments of the present disclosure provides a task management system. The task management system may include a coordinate system display module, a determination module, and a task display module. The coordinate system display module may be configured to display a three-dimensional coordinate system, dimensions of the three-dimensional coordinate system corresponding one-to-one to parameter types of a task. The determination module may be configured to determine or update parameter values of the task based on a first input from a user, the parameter values corresponding one-to-one to the parameter types. The task display module may be configured to display the task in the three-dimensional coordinate system through a stereo graphic based on the parameter values of the task, a position of the stereo graphic in the three-dimensional coordinate system being correlated with the parameter values.

One of the embodiments of the present disclosure provides a task management device. The task management device comprises at least one processor and at least one memory. The at least one memory is configured to store computer instructions, and the at least one processor is configured to execute at least a portion of the computer instructions to implement the task management method in any one of the embodiments of the present disclosure.

One of the embodiments of the present disclosure provides a computer-readable storage medium. The storage medium stores computer instructions, and when a computer reads the computer instructions in the storage medium, the computer implements the task management method in any one of the embodiments of the present disclosure.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an application scenario of a task management system according to some embodiments of the present disclosure;

FIG. 2 is a flowchart illustrating a process of a task management method according to some embodiments of the present disclosure;

FIG. 3A is a schematic diagram illustrating a three-dimensional coordinate and a target stereo graphic according to some embodiments of the present disclosure;

FIG. 3B is a schematic diagram illustrating a three-dimensional coordinate and a target stereo graphic according to some embodiments of the present disclosure;

FIG. 3C is a schematic diagram illustrating a three-dimensional coordinate and a target stereo graphic according to some embodiments of the present disclosure;

FIG. 4 is a schematic diagram illustrating different transparency of stereo graphics at different positions of a three-dimensional coordinate system according to some embodiments of the present disclosure;

FIG. 5 is a schematic diagram illustrating a graphical deformation according to some embodiments of the present disclosure;

FIG. 6A is a schematic diagram illustrating a new coordinate system displaying a task according to some embodiments of the present disclosure;

FIG. 6B is a schematic diagram illustrating a new coordinate system displaying a task according to some embodiments of the present disclosure;

FIG. 6C is a schematic diagram illustrating a new coordinate system displaying a task according to some embodiments of the present disclosure;

FIG. 7A is a schematic diagram illustrating a displayed initial stereo graphic according to some embodiments of the present disclosure;

FIG. 7B is a schematic diagram illustrating a displayed initial stereo graphic after operation according to some embodiments of the present disclosure;

FIG. 8 is a schematic diagram illustrating replica stereo graphics according to some embodiments of the present disclosure; and

FIG. 9 is a schematic diagram illustrating modules of a task management system according to some embodiments of the present disclosure.

### DETAILED DESCRIPTION

In order to more clearly illustrate the technical solutions of the embodiments of the present disclosure, the following will briefly introduce the accompanying drawings to be used in the description of the embodiments. Obviously, the accompanying drawings in the following description are only some examples or embodiments of the present disclosure, and a person of ordinary skill in the art can apply the present disclosure to other similar scenarios in accordance with these drawings without creative labor. Unless obviously obtained from the context or the context illustrates otherwise, the same numeral in the drawings refers to the same structure or operation.

It should be understood that the terms “system”, “device”, “unit” and/or “module” as used herein are a way to distinguish between different components, elements, parts, sections, or assemblies at different levels. However, the terms may be replaced by other expressions if other expressions accomplish the same purpose.

As shown in the present disclosure and the claims, unless the context clearly suggests an exception, the words “a”, “an”, “one”, “one kind”, and/or “the” do not refer specifically to the singular, but may also include the plural. Generally, the terms “including” and “comprising” suggest only the inclusion of clearly identified operations and elements that do not constitute an exclusive list, and the method, system, or device may also include other operations or elements.

Flowcharts are used in the present disclosure to illustrate operations performed by a system according to embodiments of the present disclosure. It should be appreciated that the preceding or following operations are not necessarily performed in an exact sequence. Instead, operations can be processed in reverse order or simultaneously. Also, it is possible to add other operations to these processes or remove an operation or operations from these processes.

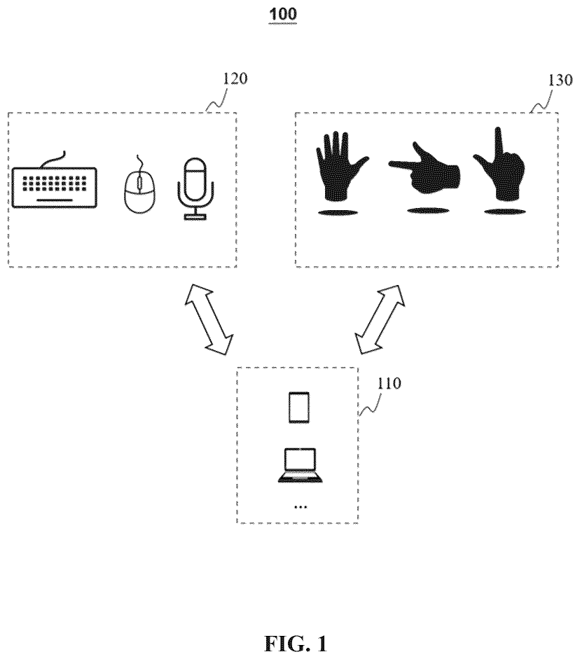

FIG. 1 is a schematic diagram illustrating an application scenario of a task management system according to some embodiments of the present disclosure.

As shown in FIG. 1, an application scenario 100 of the task management system includes a user terminal 110. As shown in FIG. 1, in the application scenario 100 of the task management system, a user may input information (e.g., a first input, a second input, a third input, a fourth input, etc.) at the user terminal 110 (e.g., a cell phone, a computer, etc.) to construct and edit a three-dimensional coordinate system or a stereo graphic. More descriptions regarding the task management system can be found in FIG. 9 and the related descriptions thereof.

In some embodiments, the user terminal 110 may utilize an assistive device 120 to obtain input from the user. For example, the user may input the information using the assistive device 120, e.g., clicking on a mouse, a keyboard, a keypad, a touch screen, voice, or the like. In some embodiments, the user terminal 110 may utilize virtual reality technology to obtain input from the user. For example, a camera can capture a hand gesture image 130 of the user, which is then used to recognize a hand gesture, or a glove/controller can be used for hand gesture recognition. The recognized hand gesture image is displayed on the user terminal 110, and the recognized hand gesture image on the user terminal 110 can change in response to the change of the user's hand gestures, i.e., virtual reality technology is combined with hand gesture recognition to input the information.

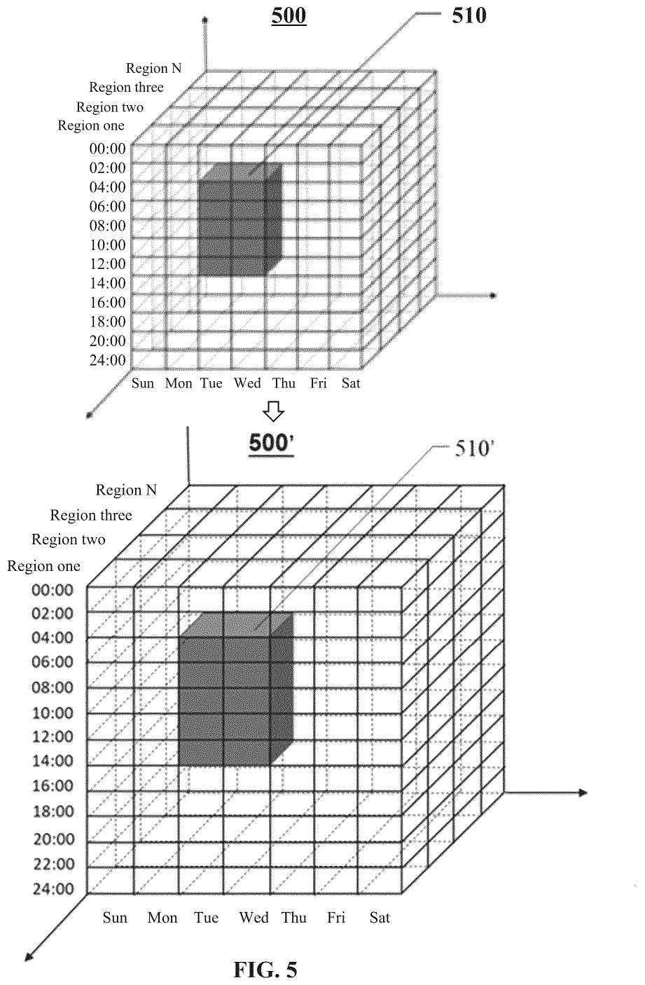

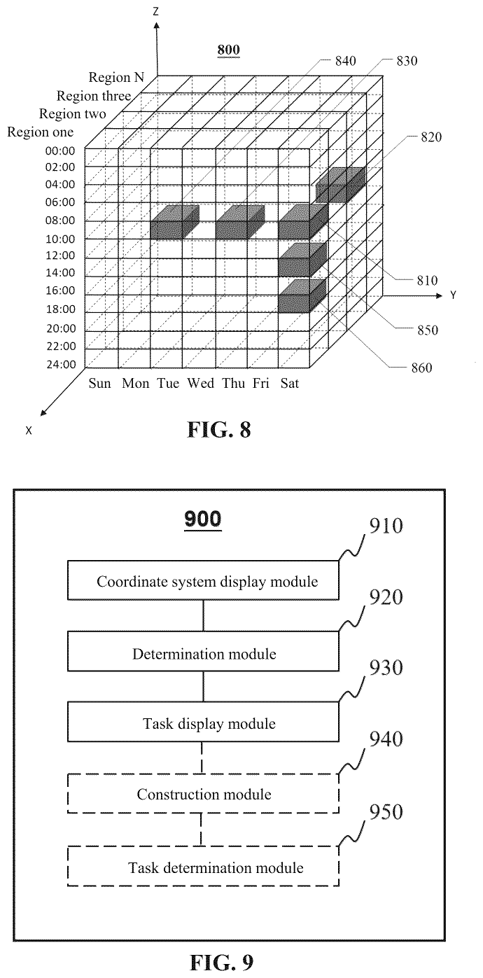

In some embodiments, the task management system installed at the user terminal 110 or a remote server may determine information related to a task based on the information entered by the user. For example, parameter values of the task may be determined or updated based on the first input from the user. As another example, content of the task may be determined based on the second input from the user. As another example, at least one replica stereo graphic of a stereo graphic is displayed based on the third input from the user. As another example, a three-dimensional coordinate system and a stereo graphic may be deformed based on the fourth input from the user. More descriptions regarding the above-described content can be found elsewhere in the present disclosure, e.g., in operation 230, FIG. 5, FIG. 8, or the like.

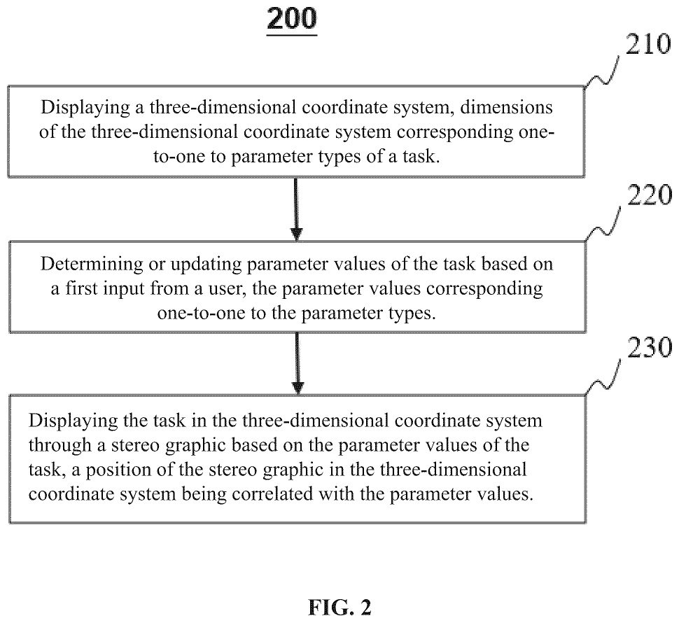

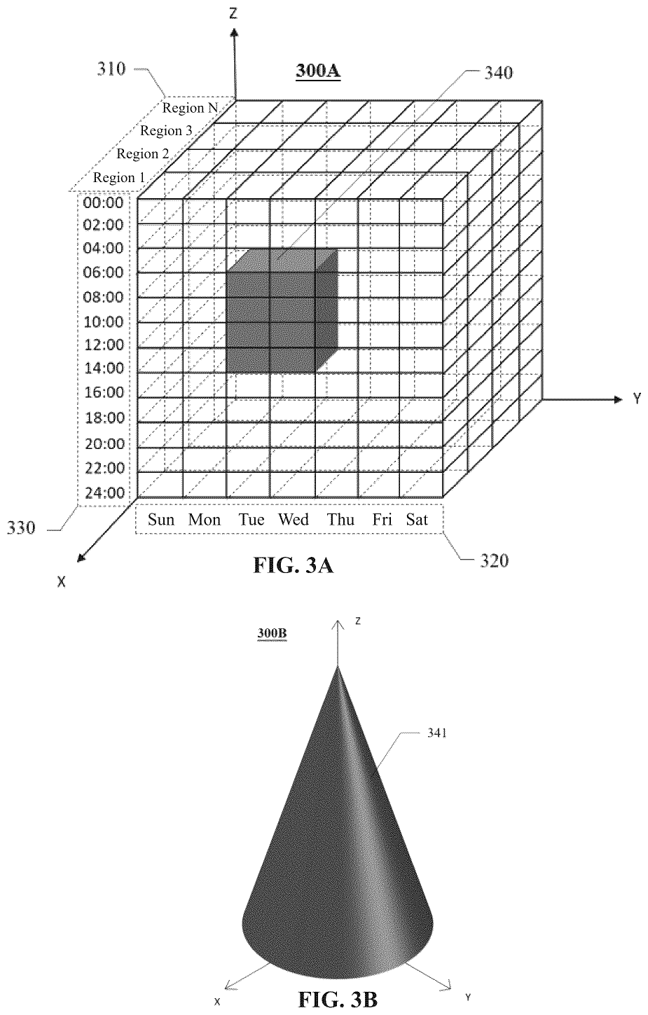

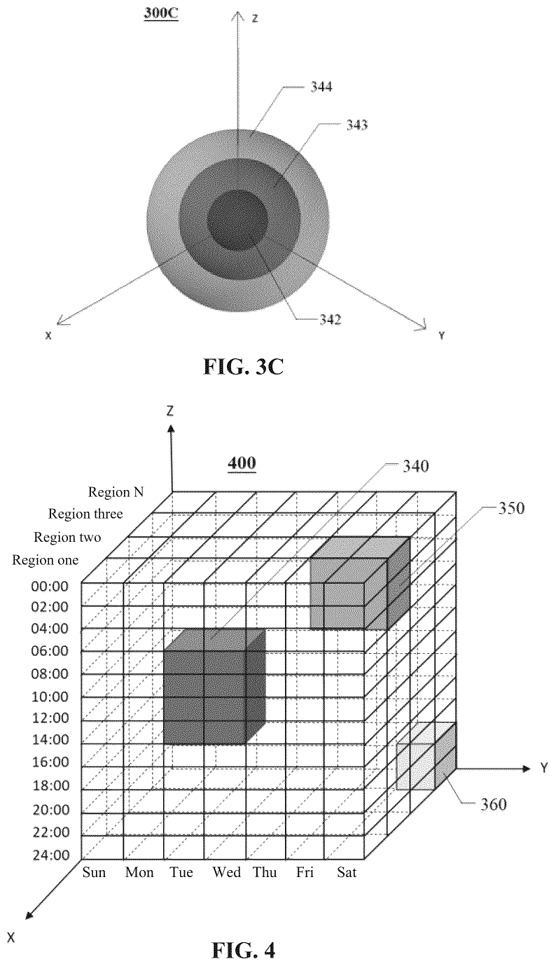

FIG. 2 is a flowchart illustrating a process of a task management method according to some embodiments of the present disclosure. FIG. 3A to FIG. 3C are schematic diagrams illustrating three-dimensional coordinates and target stereo graphics according to some embodiments of the present disclosure. The three-dimensional coordinate system in FIG. 3A to FIG. 3C is a cubic space right-angle coordinate system. For example, a three-dimensional coordinate system 300A is composed of the X-axis, Y-axis, and Z-axis, which are perpendicular to each other in pairs.

In some embodiments, as shown in FIG. 2, a process 200 of the task management method includes the following operations.

Operation 210, displaying a three-dimensional coordinate system. Dimensions of the three-dimensional coordinate system may correspond one-to-one to parameter types of a task. Operation 210 may be performed by a coordinate system display module.

The three-dimensional coordinate system refers to a coordinate system that allows task editing and display in three dimensions, wherein a position of the task in a three-dimensional space may be shown based on this coordinate system. In some embodiments, the three-dimensional coordinate system may be realized by a plurality of types of coordinate systems. For example, the three-dimensional coordinate system may be a cubic space right-angle coordinate system or a polar coordinate system, etc.

Each dimension in the three-dimensional coordinate system refers to a dimension of dimensions that make up the three-dimensional coordinate system. In some embodiments, task information is represented in the three-dimensional coordinate system based on the three dimensions together. Taking the cubic space right-angle coordinate system, i.e., the three-dimensional coordinate system 300A in FIG. 3A as an example, an execution region of the task may be determined based on the X-axis, an execution date of the task may be determined based on the Y-axis, and an execution time point of the task may be determined based on the Z-axis. In some embodiments, a parameter type of a task corresponding to each dimension of the three-dimensional coordinate system may be defined by a user.

The task refers to the related content that needs to be performed, and the task includes, but is not limited to, business work, daily life, recreational sports, or the like. For example, the task can be “Attending a meeting”, “Sending an email” “Editing a document” “Getting up to exercise” “Listening to music”, and so on.

The parameter type refers to a type of information of the task that reflects information of the task. The parameter types of the task has a correspondence with the type of coordinate scale value corresponding to each dimension of the three-dimensional coordinate system. In some embodiments, the parameter types of the task may be correspondingly set based on the acquired information of the task.

In some embodiments, the parameter types may include one or more of time and resource.

The time refers to information that reflects the execution time of the task, e.g., the time may be a maximum time for the task to be completed, e.g., “20 h”, or the time may be the deadline for the task to be completed, e.g., “next Friday 11:00-12:00”. For example, as shown in FIG. 3A, the parameter types include an execution date and an execution time.

The resource refers to the information regarding the resources that can be used to complete the task. For example, the resource may be a person, a region, a device, etc. For example, as shown in FIG. 3A, the parameter types include a region. As another example, the resource may be a relevant process, budget, personnel, etc., needed to complete the task, such as “needed IT technician, budget of $10,000, and personnel of 10, etc.”.

In the embodiments of the present disclosure, the parameter types of the task include the time and the resource, which allow for the presentation of various task requirements or demands, and enables a more detailed representation of the corresponding content in each dimension of the three-dimensional coordinate system, thereby facilitating quick access to relevant information, improving the practicality of the three-dimensional coordinate system, and enhancing the user's experience.

It is understood that the above embodiments do not serve as a limitation on the parameter types, and the parameter types may be set according to actual needs. For example, the parameter types may further include other types, such as, the environment, the assessment score, and so on.

In some embodiments, the parameter types of the task may be entered manually. In some embodiments, the parameter types of the task may be predetermined by the system.

In some embodiments, parameter information corresponding to different parameter types of the task may be displayed in different ways. The parameter information may include parameter values, levels, etc. For example, parameter information corresponding to different parameter types of the task may be displayed through marking or labeling. For example, when displaying the parameter information, the parameter information corresponding to the different parameter types of the task may be displayed using different colors. For example, the parameter information related to the time of the task may be indicated in red, and the parameter information related to the resource of the task may be indicated in green.

In some embodiments, a parameter type corresponding to at least one dimension in the three-dimensional coordinate system is determined based on a first input from the user. The first input from the user refers to an input that represents the user's construction of the task in the three-dimensional coordinate system, including an input for indicating the parameter types and/or the parameter values of the task. More descriptions regarding the first input from the user may be found in operation 220 and the related descriptions thereof.

In some embodiments, the task management system may determine the parameter types based on the first input from the user. For example, if the user inputs “A mid-year market meeting will be held in Region one this Tuesday and Wednesday from 06:00-14:00, it is very important that the entire staff attends, and speeches need to be prepared”, and accordingly, the parameter types may be determined as an execution date, execution time, execution region, importance degree, etc. It can be understood that in addition to directly inputting all the information related to the task, the input may be in a variety of ways. For example, the user may also enter task parameters based on a prompt displayed by a terminal. When displaying the task in the three-dimensional coordinate system as shown in FIG. 3A, based on the first input from the user, a parameter type corresponding to each dimension of the three-dimensional coordinate system may be determined. For example, the execution region of the task corresponding to the X-axis is “Execution location Region one”, the execution date of the task corresponding to the Y-axis is “Execution date Tuesday and Wednesday”, the execution time point of the task corresponding to the Z-axis is “execution time 06:00-14:00”, etc.

According to the embodiments of the present disclosure, by determining the parameter types based on the first input from the user, the parameter types of the task can be set according to the user's actual situation to satisfy the user's different needs, thereby improving the utility of the three-dimensional coordinate system, and enhancing the user's experience.

In some embodiments, each dimension of the three-dimensional coordinate system includes coordinate scale values.

The coordinate scale values refer to smallest size values of the parameter type represented in each dimension of the three-dimensional coordinate system. Taking FIG. 3A as an example, the X-axis may correspond to the execution region of the task, and coordinate scale values on the X-axis indicate information of an execution region 310. Each coordinate scale value on the X-axis corresponds to a specific region, such as Region one, Region two, Region three, Region N, etc. The Y-axis may correspond to the execution date of the task, and coordinate scale values on the Y-axis indicate information of an execution date 320. Each coordinate scale value on the Y-axis corresponds to a date, such as Monday, Tuesday, Wednesday, Thursday, Friday, Saturday, Sunday, etc. The Z-axis may correspond to the execution time of the task, and coordinate scale values on the Z-axis indicate information of an execution time 330. Each coordinate scale value on the Z-axis corresponds to a time period, such as 00:00-02:00, 02, 00-04:00, 04:00-06:00, 06:00-08:00, 08:00-08:00, 08:00-10:00, 10:00-12:00, 12:00-14:00, 14:00-16:00, 16:00-18:00, 18:00-20:00, 20:00-22:00, 22:00-24:00 and so on.

It should be noted that the foregoing division of the execution region, the execution date, and the execution time, and the correspondence between the execution region, the execution date, and the execution time and axis may be set correspondingly based on the actual situation. For example, the coordinate scale values on the Z-axis correspond to the execution date of the task, and each coordinate scale values correspond to a day of a month, a month of a year, and so on.

A stereo graphic is a graphic schematic generated based on execution information of the task. In some embodiments, the stereo graphic may be realized by a variety of graphs, for example, the stereo graphic may include, but is not limited to, a cube, a rectangle, a cone, a prismatic cone, a sphere, or the like. Task information (also referred to as information of the task) corresponding to the stereo graphic is related to the parameter type and the coordinate scale values corresponding to the axis on which the stereo graphic is located.

For example, in FIG. 3A, the stereo graphic 340 is a rectangle, and based on the parameter types and coordinate scale values corresponding to the axes in FIG. 3A, task information corresponding to the stereo graphic 340 may be expressed as follows: “execution date Tuesday and Wednesday, execution time 06:00-14:00, and execution region Region one”.

In some embodiments of the present disclosure, each dimension of the three-dimensional coordinate system includes coordinate scale values, which allow for the convenient and accurate determination of the numerical values corresponding to the parameter values of the task by viewing the coordinate scale values of a graphic corresponding to the task in each dimension. For example, the information, such as the execution time and location of the task can be quickly determined. Additionally, once the task's execution time and location are determined, the corresponding graphic can be generated swiftly, thereby improving human-machine interaction convenience, and enhancing editing efficiency.

In some embodiments, the three-dimensional coordinate system may have a plurality of display formats. For example, as shown in FIG. 3A, the three-dimensional coordinate system may be displayed by axis coordinates and grid lines. Only as an example, the axis coordinates and grid lines may be displayed when the task is created, and the user can edit a stereo graphic directly in the three-dimensional coordinate system or drag the edited stereo graphic into the three-dimensional coordinate system. The stereo graphic refers to a 3D graphic that is generated in the three-dimensional coordinate system based on parameter information corresponding to the task. More descriptions regarding the stereo graphic may be found in operation 230 and the related descriptions thereof. As another example, after the user inputs or drags a stereo graphic into the three-dimensional coordinate system, the three-dimensional coordinate system may display the axis coordinates and grid lines to carry on the stereo graphic reference and positioning.

In some embodiments, the three-dimensional coordinate system may display the axis coordinates and grid lines as desired. For example, the axis coordinates and grid lines may be hidden after the stereo graphic is input or dragged by the user. As another example, the axis coordinates and grid lines are only displayed when the user inputs or drags the stereo graphic or makes changes to the stereo graphic. For example, FIG. 3A is a schematic diagram when axis coordinates and grid lines are displayed, and FIG. 3B and FIG. 3C are schematic diagrams when axis coordinates and grid lines are hidden. In some embodiments, the three-dimensional coordinate system may also display three-dimensional coordinate values on demand. For example, the three-dimensional coordinate values may be hidden after the stereo graphic is input or dragged by the user. As another example, the three-dimensional coordinate values are only displayed when the user inputs or drags the stereo graphic, or makes changes to the stereo graphic.

In some embodiments, the three-dimensional coordinate system may be preset, i.e., a three-dimensional coordinate system including a plurality of types of axes may be preset, and the user may select the corresponding three-dimensional coordinate system based on the actual needs. Then the user only needs to construct or edit the stereo graphic within the selected three-dimensional coordinate system.

In some embodiments, the three-dimensional coordinate system may also be constructed by inputting the types of axes by the user. More descriptions regarding the input manner can be found in FIG. 1 and the related descriptions thereof.

In some embodiments, the task management system may edit the constructed three-dimensional coordinate system based on an input from the user. The editing includes a variety of operations such as dragging, stretching, zooming, rotating, changing parameter types, or the like.

In some embodiments, the task management system may obtain the edition type selected by the user based on a plurality of input manners and then perform the corresponding editing on the three-dimensional coordinate system. More descriptions regarding the input manner can be found in FIG. 1 and the related descriptions thereof.

Operation 220, determining or updating parameter values of the task based on the first input from the user. Operation 220 may be performed by a determination module.

In some embodiments, the first input from the user is an input that represents the user's construction of the task in the three-dimensional coordinate system. The first input includes inputs from the user to reflect the parameter types and/or the parameter values of the task. For example, the first input from the user may be “A mid-year market meeting will be held in Region one this Tuesday and Wednesday from 06:00-14:00, it is very important that the entire staff attends, and speeches need to be prepared”.

In some embodiments, the task management system may obtain the first input from the user based on a user terminal, and based on the first input from the user, the task management system may display the task through the stereo graphic in the three-dimensional coordinate system displayed at the user terminal.

In some embodiments, the input manner of the user may include a plurality, i.e., the user may input information in a variety of input manners. The input of different information may be performed using the same or different input manners. For example, a first input, a second input, a third input, and a fourth input may adopt the same or different input manners.

Hand gesture input refers to an input manner of task using the user's hand movements. For example, the hand gesture input may involve capturing the user's hand gesture through a camera and then recognizing the gesture. Alternatively, the hand gesture input may involve using gloves, controllers, or other devices to detect and recognize the user's hand gesture.

In some embodiments of the present disclosure, the input manner of the first input of the user includes the hand gesture input, which is convenient for the user to input, enhances the user's sense of participation, and improves the efficiency of human-computer interaction.

The parameter values refer to specific values of parameters corresponding to each parameter type of the task, and based on the parameter values, coordinate scale values of the stereo graphic on each dimension of the three-dimensional coordinate system may be determined. In some embodiments, the parameter values correspond one-to-one to the parameter types. For example, if the user enters “A mid-year market meeting will be held in Region one this Tuesday and Wednesday from 06:00-14:00, it is very important that the entire staff attends, and speeches need to be prepared”, corresponding parameter types may be determined as an execution date, an execution time, an execution region, an importance degree, etc., then correspondingly, parameter values may be determined as “execution date Tuesday and Wednesday”, “execution time 06:00-14:00”, “execution location Region one”, “importance degree Grade one”, etc. Further, based on the preset three-dimensional coordinate system, such as 300A shown in FIG. 3A, the finally-determined parameter types may be the execution date, the execution time, and the execution region, and then the finally-determined parameter values may be “execution date Tuesday and Wednesday”, “execution time 06:00-14:00”, and “execution location Region one”.

In some embodiments, a determination module 920 may determine or update the parameter values based on the first input from the user in a variety of ways. For example, the user may directly input the parameter values of each dimension of the three-dimensional coordinate system, or adjust the parameter values of the stereo graphic on each axis by performing operations such as dragging, zooming, or other actions on the initial stereo graphic. For example, initial parameter values of a task A is “execution date Tuesday and Wednesday”, and to adjust the execution time of the task A to “Wednesday and Thursday”, a stereo graphic corresponding to the task A is dragged to move to the right by one coordinate scale value along the Y-axis. As another example, initial parameter values of a task B is “Execution location Region one”, and to adjust the execution region of the task B to “Region three”, a stereo graphic corresponding to the task B is dragged to move backward by two coordinate scale values along the X-axis. More descriptions regarding generating a stereo graphic based on editing an initial stereo graphic can be found in FIG. 1 and the related descriptions thereof.

In some embodiments, a gradient color may be used to indicate a different importance degree or number of tasks in a stereo graphic, which is not limited by the present disclosure herein.

Operation 230, displaying the task in the three-dimensional coordinate system through the stereo graphic based on the parameter values of the task. Operation 230 may be performed by a task display module.

The stereo graphic refers to a geometric figure whose parts are not in the same plane and is generated based on the parameter values contained in the task. One stereo graphic corresponds to one task. The shape of the stereo graphic may include various shapes. For example, the stereo graphic may be a square, a rectangle, a cylinder, a cone, a prism, a sphere, or the like. For example, the stereo graphic 340 in FIG. 3A is a rectangle, a stereo graphic 341 in FIG. 3B is a cone, and a stereo graphic 342, a stereo graphic 343, and a stereo graphic 344 in FIG. 3C are all spheres.

The stereo graphic may be displayed in the three-dimensional coordinate system. A position of the stereo graphic in the three-dimensional coordinate system may be determined based on the parameter values of the task corresponding to the stereo graphic. For example, taking the three-dimensional coordinate system shown in FIG. 3A as an example, the stereo graphic 340 corresponding to a task A is a rectangle, and parameter types of the task A include an execution date, an execution time, an execution region, and parameter values of the task A include an execution date Tuesday and Wednesday, an execution time 06:00-14:00, and an execution region Region one, then in the three-dimensional coordinate system, the value of the position of the stereo graphic 340 on the Y-axis is Tuesday and Wednesday, the value of the position of the stereo graphic 340 on the Z-axis as 06:00-14:00, and the value of the position of the stereo graphic 340 on the X-axis is Region one.

In FIG. 3B, the stereo graphic 341 is a cone, and task information corresponding to the stereo graphic 341 is related to the parameter types and coordinate scale values corresponding to coordinate axes of a three-dimensional coordinate system 300B in which the stereo graphic 341 is located. For example, in the three-dimensional coordinate system 300B in FIG. 3B, if the X-axis indicates an execution time, the Y-axis indicates an execution region, and the Z-axis indicates an importance degree, then the radius of the largest circle of the bottom surface of the cone may be determined based on an execution time and an execution region of a task (e.g., a distance between a point on the X-Y plane determined based on the execution time and execution region of the task and an origin of the coordinate system may be used as the radius of the largest circle of the bottom surface of the cone), a distance between the apex of the cone and the X-Y plane may be determined based on an important level of the task, then based on the execution time, the execution region, and the importance level of the task, a cone corresponding to the task may be determined.

In FIG. 3C, the stereo graphic 342 is a sphere, task information corresponding to the stereo graphic 342 is related to the parameter types and coordinate scale values of coordinate axes of a three-dimensional coordinate system 300C in which the stereo graphic 342 is located, and the specific parameter types and coordinate scale values may be set based on specific application scenarios. For example, in the three-dimensional coordinate system 300C, the X-axis, Y-axis, and Z-axis may correspond to an execution time, an execution region, and an execution date, respectively, so based on an execution time, an execution region, and an execution date of a task, the center of the sphere corresponding to the task may be determined, and based on an importance degree of the task, the radius of the sphere may be determined, e.g., the more important the task is, the smaller or larger the radius of the sphere is.

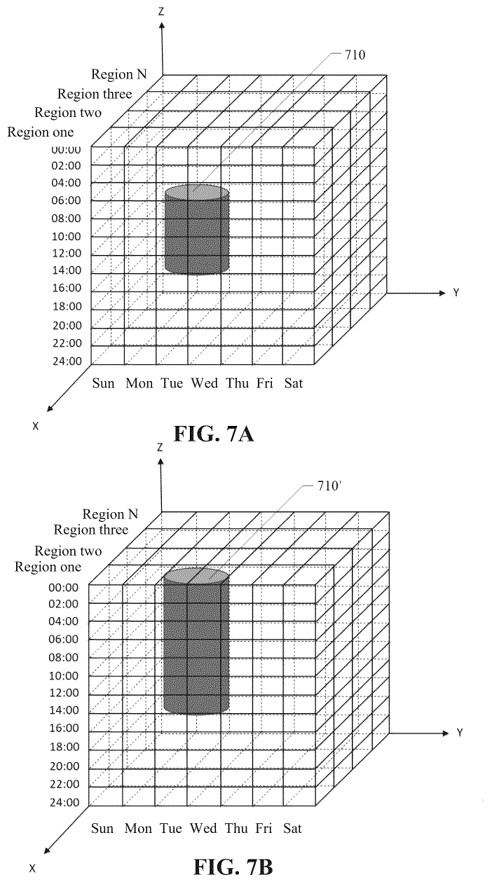

In some embodiments, the shape of the stereo graphic may be pre-set. For example, the stereo graphic may be preset to be of various shapes, such as a square, rectangle, cylinder, cone, prismatic cone, sphere, or the like. The user may input/drag the preset graphic template into the three-dimensional coordinate system. In some embodiments, the user may perform operations on a displayed initial stereo graphic, the operations including at least one of zooming or dragging. More descriptions regarding the initial stereo graphic and the operations can be found in FIG. 7 and the related descriptions thereof.

In some embodiments, the task management system may enable personalization of the stereo graphic in conjunction with the user, e.g., the task management system may determine templates for different stereo graphics based on different user information. For example, the task management system may, based on user identification, obtain historical stereo graphic usage information of the user, determine a shape of a stereo graphic that the user is likely to use, and generate a stereo graphic template of the corresponding shape.

In some embodiments, the user may construct the stereo graphic in the three-dimensional coordinate system by entering parameter values corresponding to the parameter types of the task. For example, as shown in FIG. 3A, after inputting “execution date is Tuesday and Wednesday, execution time is 06:00-14:00, execution Region is Region one”, the stereo graphic 340 may be automatically constructed in the three-dimensional coordinate system.

In some embodiments, after the stereo graphic is constructed in the three-dimensional coordinate system, the user may edit the stereo graphic. The editing includes dragging, zooming, etc. Based on the editing of the stereo graphic, the parameter values of the parameter types corresponding to the task may be adjusted. For example, as shown in FIG. 3A, the editing may be stretching or zooming the stereo graphic, and correspondingly, the execution date, the execution time, and the execution region of the task may be adjusted. In some embodiments, the editing may also include changing the importance degree of the task, etc. As shown in FIG. 3C, for example, the editing may be to change the color of the stereo graphic, so the importance degree of the task, etc., may be adjusted. For example, the darker the color is, the higher the importance degree of the task is. For example, in FIG. 3C, a stereo graphic 342 with the darkest color represents the highest importance degree of the task; a stereo graphic 343 with the lighter color represents the slightly lower importance degree of the task; and a stereo graphic 344 with the lightest color represents the lowest importance degree of the task. The obtaining manner of the editing information can be referred to the descriptions of obtaining the user input in FIG. 1.

More descriptions regarding editing the stereo graphic can be found in FIG. 5 and FIG. 7 and the related descriptions thereof.

In some embodiments, the task management system may replicate a plurality of stereo graphics at once based on the user input. For example, if the same task, such as playing the same music, is performed at the same period and in the same region each day from Monday through Friday, a plurality of stereo graphics may be generated at once, or a stereo graphic may be generated at once and then a plurality of stereo graphics may be generated by replicating the stereo graphic and the plurality of stereo graphics may be placed in corresponding positions in the three-dimensional coordinate system. More descriptions regarding the replication of the stereo graphic can be found in FIG. 8 and the related descriptions thereof.

In some embodiments, the task management system may edit a plurality of stereo graphics at once based on the user input. For example, all stereo graphics may be moved one unit cell to the right along the Y-axis, etc. It is understandable that when the editing content is the same, the editing by one input can improve editing efficiency and reduce repetitive actions by users.

In some embodiments, the determination module may determine the content of the task (also referred to as task content) based on the second input from the user.

The second input from the user refers to a user input that reflects the content of the task, e.g., the second input from the user may be the content of an email, the content of a meeting, or the like. In some embodiments, the second input may be part of the first input. That is, the content of the second input may be determined based on the first input from the user.

In some embodiments, the user terminal may obtain the second input from the user in a variety of ways. The second input is obtained in a manner similar to the first input. More descriptions regarding the input manner can be found in FIG. 1 and the related descriptions thereof.

The content of a task refers to the specific content that needs to be accomplished during the execution of a task in a particular task type. For example, in an advertisement-type task, task content 1 may be to play a Coke advertisement, task content 2 may be to play a cosmetics advertisement, or the like.

In some embodiments, the determination module may determine the content of the task based on the second input from the user, and based on different input manners, different approaches may be used to determine the input content. For example, if the user inputs through voice, voice analysis may be used to obtain the content of the task contained in the voice input by the user. For example, the user inputs “prepare a speech for the mid-year meeting”, and the task content may be determined by the voice analysis to be “prepare a speech”. More descriptions regarding the input manner can be found in FIG. 1 and the related descriptions thereof.

In some embodiments of the present disclosure, by determining the content of the task based on the second input from the user, it can automatically obtain the content of the task contained therein based on the input from the user, thereby reducing the operation of the user and enhancing the utility of the task management system.

In some embodiments, the determination module 920 may determine categorization of the task, and based on the categorization of the task, labeling information of the stereo graphic may be displayed.

The categorization of the task refers to categorization information corresponding to each task. Different categorization information of the task may be obtained based on different categorization standards. For example, based on the occurrence frequency of a task, the categorization of the task may include a periodic task, a temporary task, etc. As another example, based on the importance degree of a task, the categorization of the task may include an important task, a general task, etc. The specific categorization standard may be preset or be determined by the system's default settings.

In some embodiments, the categorization of the task may include a categorization of a task type, a categorization of a content type, a categorization of a date, a categorization of a time, a categorization of a region, or the like. For example, a task type 1 is an advertisement, a task type 2 is music, a task type 3 is an announcement, etc. As another example, the execution date of the task type 1 is the first half of this month, the execution date of the task type 2 is the middle of this month, and the execution date of the task type 3 is the second half of this month, etc. As another example, the execution time of the task type 1 is the working time of 09:00-18:00, the execution time of the task type 2 is the non-working time of 18:00-24:00, etc. As another example, the execution region of the task type 1 is an office, the execution region of the task type 2 is a building base, etc.

The labeling information refers to the information related to labeling the stereo graphic, and the labeling information may be a categorization result of the task. For example, a label 1 may be the categorization result of the task type, such as “daily work”; a label 2 may be the categorization result of the content type, such as “sending file”; a label 3 may be the categorization result of the date, such as “this week”; a label 4 may be the categorization result of the time, such as “morning”; and a label 5 may be the categorization result of the region, such as “company plant”, or the like.

In some embodiments, the labeling information of the stereo graphic may be displayed based on the categorization of the task through the three-dimensional coordinate system. In some embodiments, the labeling information may be displayed in various forms. For example, the labeling information may be displayed in a label form, in an annotation form, or the like. In some embodiments, the labeling information may also be embodied by rendering the stereo graphic in a color or pattern. For example, it may be predetermined that different categorization information corresponds to different graphic colors or patterns, and then based on the categorization of the task, the color or pattern of the stereo graphic may be determined and displayed based on the categorization of the task.

In some embodiments, the stereo graphic and the content of the task corresponding to the stereo graphic may be displayed on the user terminal. For example, the content may be displayed within a predetermined range associated with the stereo graphic while the stereo graphic is displayed. As another example, in response to a first triggering operation from the user, the content of the task may be displayed within a predetermined range associated with the stereo graphic.

The first triggering operation from the user is a related operation that can affect the subsequent display of the stereo graphic. The first triggering operation may be a mouse click, a screen touch, a hand gesture, and other operations.

The predetermined range refers to a predefined region within the stereo graphic where the content information of the task is displayed. For example, the predetermined range may be the front or top of the stereo graphic, and the specific position of the predetermined range may be preset.

In some embodiments of the present disclosure, in response to the first triggering operation from the user, the content of the task is displayed in a preset position, so that the user can quickly obtain specific content information of the task and reduce unnecessary actions when retrieving information.

In some embodiments of the present disclosure, by determining the parameter types based on the first input from the user, corresponding parameter types of the task may be set according to the user's actual situation to meet the user's different needs, thereby improving the utility of the three-dimensional coordinate system and enhancing the user's experience.

It should be noted that the foregoing description with respect to operations 210-230 is for exemplification and illustration only and does not limit the scope of application of the present disclosure. For a person skilled in the art, various corrections and changes can be made to operations 210-230 under the guidance of the present disclosure. However, these corrections and changes remain within the scope of the present disclosure.

FIG. 4 is a schematic diagram illustrating different transparency of stereo graphics at different positions of a three-dimensional coordinate system according to some embodiments of the present disclosure.

In some embodiments, the determination module may determine a transparency of a stereo graphic based on a position of the stereo graphic in the three-dimensional coordinate system.

The transparency refers to the degree to which the stereo graphic allows light to pass through it. For example, the transparency may be expressed as a numerical value in a range of 0 to 1. As another example, the transparency may be expressed as a percentage in a range of 0% to 100%. The greater the value or percentage, the greater the transparency. As another example, the transparency may be expressed in terms of color depth or degree of light transmission, with darker colors representing lower transparency and higher degrees of light transmission representing higher transparency.

The transparency of the stereo graphic may be determined in a number of manners.

In some embodiments, the transparency of the stereo graphic may be related to the importance degree of a task to which the stereo graphic corresponds. The higher the importance degree of the task, the less transparency the corresponding stereo graphic. The transparency of the stereo graphics corresponding to tasks of different importance degrees may be preset. For example, for a task whose importance degree is Degree 1, the transparency of its corresponding stereo graphic may be set to 0%, and for a task whose importance degree is Degree 3, the transparency of its corresponding stereo graphic may be set to 80%, or the like.

In some embodiments, the transparency of the stereo graphic may also be correlated with the execution time of the task corresponding to the stereo graphic. For example, a stereo graphic corresponding to a task executed on a Monday has a higher transparency, and a stereo graphic corresponding to a task executed on a Tuesday has a lower transparency, to efficiently remind different execution times.

In some embodiments, the transparency of the stereo graphic may also be correlated with the position of the stereo graphic in the three-dimensional coordinate system. As shown in FIG. 4, it can be considered that, with the Y-axis as the reference, the smaller the distance from the X-axis in the positive direction, the further back the layer is; conversely, the greater the distance from the Y-axis, the forward the layer is. The transparency of the stereo graphic may be set according to the layer order. The further back the layer is, the lower the transparency may be. For example, among three stereo graphics in a three-dimensional coordinate system 400 shown in FIG. 4, a stereo graphic 360 has the smallest distance from the Y-axis, making it the furthest back in layer, so its corresponding transparency is relatively high, such as 80%, a stereo graphic 350 has a distance from the Y-axis greater than the stereo graphic 360 but smaller than a stereo graphic 340, placing it in the middle layer, so its transparency is moderate, such as 50%, and the stereo graphic 340 has the largest distance from the Y-axis, making it furthest forward in layer, so its transparency is relatively low, such as 20%, or the like.

In some embodiments, the transparency of the stereo graphic may also be set by a user. For example, the transparency of the stereo graphic corresponding to each task is set based on user input. In some embodiments, the transparency of the stereo graphic corresponding to each type of task may also be preset, and thus the transparency of the stereo graphic may be determined based on the type of task.

In some embodiments of the present disclosure, by determining the transparency of the stereo graphic based on the position of the stereo graphic in the three-dimensional coordinate system, making the stereo graphic displayed more clearly with a greater sense of layering, which allows the user to easily process tasks based on the transparency of the stereo graphic, making the importance degree and other relevant information of the task immediately apparent, thereby enhancing the user's experience.

FIG. 5 is a schematic diagram illustrating deformation of a three-dimensional coordinate system and a stereo graphic according to some embodiments of the present disclosure.

In some embodiments, a three-dimensional coordinate system and a stereo graphic may be deformed based on a fourth input from a user.

The fourth input from the user refers to an input from the user for deforming the stereo graphic and the three-dimensional coordinate system, and based on the fourth input from the user, a determination module may determine deformation parameters of the stereo graphic and the three-dimensional coordinate system. In some embodiments, the fourth input may be used as part of a first input.

The deformation parameters of the stereo graphic and the three-dimensional coordinate system refer to the parameters based on which deformation is performed on the stereo graphic and the three-dimensional coordinate system with respect to features such as shape, size, or the like. In some embodiments, the deformation parameters may be preset. For example, the deformation parameters may be numerical values, such as +2 or −80%. The specific values, 2 and 80% may represent the scaling ratio, where a positive value indicates zooming in, and a negative value indicates zooming out. For example, +2 and −80% correspond to deformation parameters of a magnifying by 2 times and reducing by 80%, respectively.

The deformation parameters may also be an angle, such as +90°, where 90° may indicate an angle of rotation, and + may be indicated as a clockwise rotation, e.g., +90° refers to a clockwise rotation of 90°. In some embodiments, the deformation of the stereo graphic and/or the three-dimensional coordinate system may include at least one of scaling or rotation.

Scaling refers to the operation of shrinking or enlarging the three-dimensional coordinate system and the stereo graphic. For example, reducing the length of one unit scale on the coordinate axes of the three-dimensional coordinate system from 2 cm to 1 cm, or enlarging a stereo graphic originally sized (4 cm*4 cm*4 cm) to (8 cm*8 cm*8 cm), or the like.

For example, as shown in FIG. 5, taking the example of scaling a three-dimensional coordinate system 500 and a stereo graphic 510, the fourth input from the user may be a voice command to zoom in 2 times or a keyboard input of +2. Based on the fourth input from the user, a scaled version of a three-dimensional coordinate system 500′ and a stereo graphic model 510′, each twice the original size of the three-dimensional coordinate system 500 and the stereo graphic 510 may be obtained.

The rotation refers to an operation in which the three-dimensional coordinate system and the stereo graphic may be rotated around a datum point or a datum axis, and the datum point or the datum axis may be preset or selected, or set by the user. For example, if the fourth input from the user is a voice command for a 90° clockwise rotation or a keyboard input of +90°, based on the fourth input, the deformation parameters may be the stereo graphic being rotated 90° clockwise around a datum point or a datum axis.

As described in some embodiments of the present disclosure, the deformation performed on the three-dimensional coordinate system and the stereo graphic as a whole can display the task more in line with the needs of the user and enhance the user experience.

In some embodiments, the deformation of the stereo graphic and the three-dimensional coordinate system may also include adjusting the transparency, shape, etc., of the stereo graphic and the three-dimensional coordinate system. The specific deformation information may be set in conjunction with the user's needs.

In some embodiments, the deformation may also be separately performed on the stereo graphic corresponding to the task and the three-dimensional coordinate system corresponding to the task. For example, scaling, rotation, or the like are separately performed on the stereo graphic and the three-dimensional coordinate system. More descriptions regarding deforming the stereo graphic can be found in FIG. 7 and the related descriptions thereof.

In some embodiments, a user terminal may obtain the fourth input from the user in a variety of manners. The fourth input may be input in a manner similar to that of the first input, and details regarding the input manner of the first input please refer to FIG. 1 and the related descriptions thereof. By deforming the three-dimensional coordinate system and the stereo graphic based on the fourth input from the user as described in some embodiments of the present disclosure, the deformation of the three-dimensional coordinate system and the stereo graphic can be set according to the user's actual situation to meet the user's personalized needs and enhance the user experience.

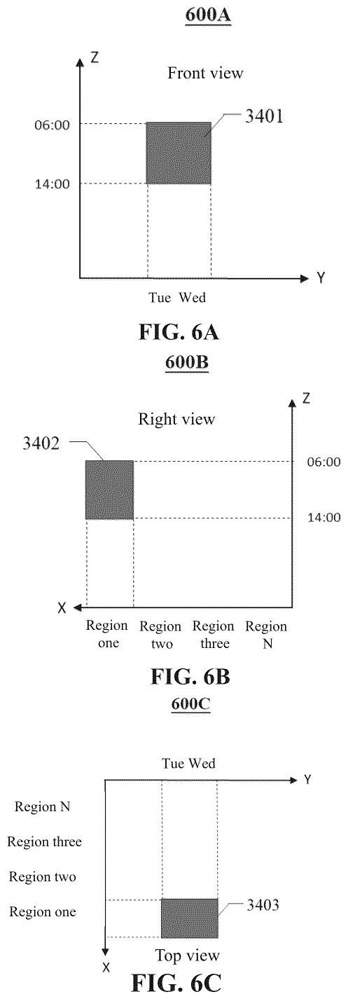

FIG. 6A to FIG. 6C are schematic diagrams illustrating a task being displayed in a new coordinate system according to some embodiments of the present disclosure.

In some embodiments, a construction module 940 may construct a new coordinate system based on one or two dimensions of a three-dimensional coordinate system, and display a task in the new coordinate system based on parameter values of the task in the one or two dimensions.

In some embodiments, the new coordinate system is a coordinate system constructed based on the one or two dimensions of the three-dimensional coordinate system. As an example, the new coordinate system is constructed based on two dimensions of the three-dimensional coordinate system. As shown in FIG. 6A to FIG. 6C, the new coordinate system may include any two axes of the three-dimensional coordinate system, such as the Y-axis and the Z-axis, the X-axis and the Z-axis, or the X-axis and the Y-axis. In some embodiments, the new coordinate system may also be constructed based on only one dimension of the three-dimensional coordinate system, e.g., the new coordinate system is a one-dimensional coordinate system including only one of the X-axis, the Y-axis, or the Z-axis.

In some scenarios where it is not necessary to focus on specific dimensions of the task, such as focusing only on task management in a certain region (e.g., Region one, etc.) and/or focusing only on task management in a certain period (e.g., 6:00 to 14:00, etc.), a new coordinate system may be constructed and the task may be displayed in the new coordinate system, thus simplifying the display of the task and making displaying manner of the task management system more intuitive, making it easier for users to access information quickly.

In some embodiments, the new coordinate system may be determined in a variety of manners. For example, the new coordinate system may be constructed based on parameter types that need to be focused on. For example, when only information related to the execution time of the task is required, a new two-dimensional coordinate system 600A may be constructed based on the Y-axis (corresponding to the execution date) and the Z-axis (corresponding to the execution time) in the three-dimensional coordinate system 300A in FIG. 3A, and the coordinate scale values of the two axes of the new two-dimensional coordinate system 600A may correspond to the coordinate scale values of the Y-axis and the Z-axis in the three-dimensional coordinate system 300A, respectively.

In some embodiments, the display of the task in the new coordinate system may be in the form of a projection of a stereo graphic corresponding to the task along one of the directions in the three-dimensional coordinate system. As shown in FIG. 6A, a planar graphic 3401 in the two-dimensional coordinate system 600A is a projection of the stereo graphic 340 from the front view in the three-dimensional coordinate system, and correspondingly, the planar graphic 3401 in the new coordinate system corresponds to execution dates of Tuesday and Wednesday and execution time of 6:00 to 14:00. As another example, a two-dimensional coordinate system 600B is constructed based on the X-axis and the Z-axis in the three-dimensional coordinate system 300A in FIG. 3. As shown in FIG. 6B, the X-axis and Z-axis in the two-dimensional coordinate system 600B correspond to the X-axis and Z-axis in the three-dimensional coordinate system 300A in FIG. 3A, respectively, and a planar graphic 3402 in the two-dimensional coordinate system 600B is a projection of the stereo graphic 340 from the right view in the three-dimensional coordinate system, and correspondingly, the planar graphic 3402 in the two-dimensional coordinate system 600B corresponds to the execution region of Region one and the execution time of 6:00 to 14:00. As another example, a two-dimensional coordinate system 600C is constructed based on the X-axis and the Y-axis in the three-dimensional coordinate system 300A in FIG. 3A. As shown in FIG. 6C, the X-axis and the Y-axis in the two-dimensional coordinate system 600C correspond to the X-axis and the Y-axis in the three-dimensional coordinate system in FIG. 3A, respectively, and a planar graphic 3403 in the two-dimensional coordinate system 600C is a projection of the stereo graphic 340 from the top view in the three-dimensional coordinate system, and correspondingly, the planar graphic 3403 in the new two-dimensional coordinate system 600C corresponds to the execution region of Region one and the execution date of Tuesday to Wednesday.

In some embodiments of the present disclosure, the task is displayed in the new coordinate system based on the parameter values of the task in the corresponding dimensions, and in some scenarios where it is not necessary to focus on a specific dimension, some of the dimensions can be omitted, simplifying the display of the task, making the displaying manner of the task management system more intuitive, and facilitating users to quickly access the information they need.

FIG. 7A and FIG. 7B are schematic diagrams illustrating operating a displayed initial stereo graphic according to some embodiments of the present disclosure, wherein a stereo graphic 710 in FIG. 7A is an initial stereo graphic and a stereo graphic 710′ in FIG. 7B is a stereo graphic after being operated by a user.

In some embodiments, a first input may include an operation of the user on the displayed initial stereo graphic, the operation including at least one of zooming or dragging.

The initial stereo graphic may be a stereo graphic displayed on a user terminal that has not been operated by the user, e.g., as shown in FIG. 7A, the initial stereo graphic may be the initial stereo graphic 710.

In some embodiments, an initial position of the initial stereo graphic in a three-dimensional coordinate system may be a system default position or a position preset by users. For example, as shown in FIG. 7A, an initial position corresponding to the initial stereo graphic 710 is as follows: the execution region is Region one, the execution date is Tuesday to Wednesday, and the execution time is from 6:00 to 14:00. Before the user operates on the initial stereo graphic, the initial stereo graphic may be displayed based on the initial position, the user may change the position of the stereo graphic in the three-dimensional coordinate system based on the corresponding operation performed on the initial stereo graphic.

In some embodiments, the initial position of the initial stereo graphic in the three-dimensional coordinate system may be determined through prediction based on relevant information of the user.

In some embodiments, the relevant information of the user refers to the identity information of the user, setting information of a historical task, and information (including parameter types and/or parameter values) of the task type corresponding to the initial stereo graphic, etc. For example, for a user named Zhang San, most of the setting data of his “weekly summary” meeting task is carried out at 16:00-18:00 on Fridays in Region one, it may be predicted that the initial position of a “weekly summary” meeting task is 16:00-18:00 on Friday in Region one.

In some embodiments, the initial stereo graphic may be determined by retrieving vectors in a vector library. The vector library includes a plurality of history vectors, the history vectors being determined based on history-related information, and the history-related information includes a construction time, information of a constructer, or the like. Elements in the history vectors may correspond to any of the history-related information. Each of the history vectors in the vector library corresponds to information of each task type. Determining vectors to be matched based on information and time of a current user, determining target history vectors by retrieving the vector library based on the vectors to be matched, and information of a task type corresponding to the target history vectors is designated as the initial position of the initial stereo graphic in the three-dimensional coordinate system.

In some embodiments, the construction module 940 may collect and organize data of various historical tasks for each user, and compile the specific execution information (including parameter types and/or parameter values of historical tasks) for each task type for each user, which results in a task execution information reference table for each user. After obtaining the information of the user and the information of the task type, the initial position of the stereo graphic in the three-dimensional coordinate system may be determined based on the task execution information reference table.

In some embodiments, the position of the initial stereo graphic in the three-dimensional coordinate system may also be determined based on processing the relevant information of the user using a prediction model, the prediction model being a machine learning model.

In some embodiments, the prediction model may be obtained by training. For example, training samples are input to an initial prediction model, and a loss function is constructed based on labels of the training samples and the output of the initial prediction model, and the parameters of the initial prediction model are updated, and when the loss function of the initial prediction model satisfies the predetermined condition, the model training is completed. The predetermined condition may be that the loss function converges, the number of iterations reaches a threshold, or the like.

In some embodiments, the training samples may be a plurality of pieces of information of historical users, and the training samples may be obtained based on historical data. The labels of the training samples may be positions of stereo graphics corresponding to the plurality of pieces of information of historical users. The labels may be manually labeled.

In some embodiments, the user may perform operations such as zooming, dragging, or the like on the displayed initial stereo graphic in the three-dimensional coordinate system based on an actual task execution plan. For example, after the user performs a stretching operation on the initial stereo graphic 710 in FIG. 7A, the stretched stereo graphic 710′ shown in FIG. 7B may be generated. The stretched stereo graphic 710′ is obtained by stretching the initial stereo graphic 710 in the positive direction of the Z-axis by 3 units. The parameter values corresponding to the stretched stereo graphic 710′ include the execution region of Region one, the execution date of Tuesday and Wednesday, and the execution time from 00:00 to 14:00.

In some embodiments, a zooming operation refers to an operation that changes the volume of the stereo graphic while keeping the shape of the stereo graphic unchanged. For example, the zooming operation may be an operation that changes parameter values in the remaining dimensions of the stereo graphic while keeping parameter values in one or two dimensions of the stereo graphic unchanged.

In some embodiments, the zooming operation may include a stretching operation, for example, as shown in FIG. 7A and FIG. 7B, the parameter values of the initial stereo graphic 710 on the X-axis and Y-axis may be kept unchanged, and the initial stereo graphic 710 may be subjected to a stretching operation in the positive direction of the Z-axis to generate the stretched stereo graphic 710′. In some embodiments, the stretching operation may further include a contraction operation, the contraction operation being an operation in which the zooming direction is opposite to the zooming direction of the stretching operation.

In some embodiments, a dragging operation (which may also be referred to as a translation operation) refers to an operation that maintains the shape of the stereo graphic in the three-dimensional coordinate system unchanged and only changes the position of the stereo graphic in the three-dimensional coordinate system, i.e., an operation that maintains the difference between the maximum parameter values and the minimum parameter values of the stereo graphic on any dimension unchanged and changes the position of the stereo graphic on at least one axis of the three-dimensional coordinate system. For example, the dragging operation may be to drag the initial stereo graphic 710 to a position of an execution region of Region one, an execution date of Friday to Saturday, and an execution time of 0:00 to 8:00 in the three-dimensional coordinate system, or to drag the initial stereo graphic 710 to a position in an execution region of Region three, an execution date of Monday to Tuesday, and an execution time of 2:00 to 10:00 in the three-dimensional coordinate system.

In some embodiments, the user may input a desired operation in various input manners. For example, the user may directly zoom in and zoom out stereo graphics in FIG. 3A to FIG. 3 by clicking on a mouse or through hand gestures to change the coverage of the task. More descriptions regarding the input manner can be found in FIG. 1 and the related descriptions thereof.

The task management method disclosed in the embodiments of the present disclosure generates the graphic corresponding to a task based on the user's operation on the displayed initial stereo graphic, which enables the user to update the parameter values of the task more conveniently, improves the efficiency of the generation and management of the task, and facilitates the user's rapid access to the required information.

FIG. 8 is a schematic diagram illustrating replica graphics according to some embodiments of the present disclosure.

In some embodiments, a task display module 930 may display, based on a third input from a user, at least one replica stereo graphic of a stereo graphic. The at least one replica stereo graphic and the stereo graphic have a same parameter value of at least one parameter type.

The third input from the user refers to a replication command entered by the user, for example, the third input may include: selecting a stereo graphic to be replicated, parameter types to be replicated (i.e., parameter types whose parameter values need to be kept the same when replicated), changing parameter types and change values of the changing parameter types, a replication operation, or the like.

In some embodiments, the parameter types to be replicated refer to at least one parameter type of the stereo graphic to be replicated. The task display module may determine a position of the replica stereo graphic in a three-dimensional coordinate system based on the stereo graphic to be replicated, the parameter types to be replicated, the changing parameter types, and the changing values of the changing parameter types, and display the replica stereo graphic in the three-dimensional coordinate system.

In some embodiments, the task display module may determine the position of the replica stereo graphic in the three-dimensional coordinate system based on the stereo graphic to be replicated and the replication operation, and display the replica stereo graphic in the three-dimensional coordinate system. The replication operation may include: replicating at intervals of certain parameter values, replicating through dragging, replicating based on a base point, or the like.

In some embodiments, the user may input the replication command in various input manners such as voice input, hand gesture input, mouse input, etc., and more descriptions regarding the input manner can be found in FIG. 1 and the related descriptions thereof.

The replica stereo graphic refers to a stereo graphic that has been duplicated, and the replica stereo graphic may represent the replication of a task, e.g., each replica stereo graphic corresponds to a replica task.

In some scenarios, the user may need to replicate the same task, for example, to perform the same task during a fixed period every day, to perform the same task multiple times on the same day, or to perform the same task multiple times in the same region. The task display module 930 may generate a plurality of tasks at once, or replicate a task as a plurality of tasks.

In some embodiments, the user may replicate a task (e.g., music playback, advertisement playback, etc.) to different regions. For example, as shown in FIG. 8, in a three-dimensional coordinate system 800, parameter information corresponding to a stereo graphic to be replicated 810 includes as follows: an execution task is music playback, an execution region is Region one, an execution date is Saturday, and an execution time is from 8:00 to 10:00, and the user performs a replication operation on the stereo graphic to be replicated 810 to obtain a first replica stereo graphic 820, then the first replica stereo graphic 820 has an execution task of music playback, an execution region of Region three, an execution date of Saturday, and an execution time of 8:00 to 10:00.

In some embodiments, the user may replicate the task to different dates. For example, as shown in FIG. 8, if the user performs a replication operation on the stereo graphic to be replicated 810 to obtain a second replica stereo graphic 830 and a third replica stereo graphic 840, the second replica stereo graphic 830 has an execution task of music playback, an execution region of Region one, an execution date of Thursday, and an execution time of 8:00 to 10:00, and the third replica stereo graphic 840 has an execution task of music playback, an execution region of Region one, an execution date of Tuesday, and an execution time of 8:00 to 10:00.

In some embodiments, the user may replicate the task to different periods. For example, as shown in FIG. 8, if the user performs a replication operation on the stereo graphic to be replicated 810 to obtain a fourth replica stereo graphic 850 and a fifth replica stereo graphic 860, the fourth replica stereo graphic 850 has an execution task of music playback, an execution region of Region once, an execution date of Saturday, and an execution time of 12:00 to 14:00, and the fifth replica stereo graphic 860 has an execution task of music playback, an execution region of Region one, an execution date of Saturday, and an execution time of 16:00 to 18:00.

In some embodiments, the replica stereo graphic may be displayed in the same form as the stereo graphic to be replicated, as shown in FIG. 8, the replica stereo graphic and the stereo graphic to be replicated all have the same color, transparency, or the like.

In some embodiments, the replica stereo graphic may be displayed in a different form from the stereo graphic to be replicated for differentiation. For example, the replica stereo graphic may be marked with a particular marking or color, or the transparency of the replica stereo graphic may be different from that of the stereo graphic to be replicated, etc.

In some embodiments, the user may further perform operations such as stretching, scaling, rotating, or other editing operations on the replica stereo graphic to quickly generate tasks with different parameter values.

The task management method disclosed in the embodiments of the present disclosure allows for the rapid generation of the replica stereo graphic based on existing stereo graphics, enabling the user to reduce the creation time of the same task and improve the efficiency of task management.

FIG. 9 is a schematic diagram illustrating modules of a task management system 900 according to some embodiments of the present disclosure. As shown in FIG. 9, the task management system 900 includes a coordinate system display module 910, the determination module 920, and the task display module 930. The coordinate system display module 910 may be configured to display a three-dimensional coordinate system. Dimensions of the three-dimensional coordinate system corresponding one-to-one to parameter types of a task. The determination module 920 may be configured to determine or update parameter values of the task based on a first input from a user. The parameter values correspond one-to-one to the parameter types. The task display module 930 may be configured to display the task in the three-dimensional coordinate system through a stereo graphic based on the parameter values of the task. A position of the stereo graphic in the three-dimensional coordinate system is correlated with the parameter values. More descriptions of the task management system 900 can be referred to the related description of the task management method in the above embodiment, e.g., operation 210 to operation 230.

The task management system described in the embodiments of the present disclosure determines the parameter types based on the first input from the user, and the corresponding parameter types of the task can be set according to the user's actual situation to satisfy the user's different needs, thereby improving the utility of the three-dimensional coordinate system, and enhancing the user's experience.

In some embodiments, the parameter types include one or more of time or resource. More descriptions of the parameter types can be found elsewhere in the present disclosure, for example, in the description of parameter types in FIG. 3A.

In some embodiments, the task management system 900 further includes a construction module 940. The construction module 940 is used to construct a new coordinate system based on one or two dimensions in the three-dimensional coordinate system, and the task display module 930 is further used to display a task in the new coordinate system based on the parameter values of the task in the one or two dimensions. More descriptions of the construction module 940 may be found elsewhere in the present disclosure, for example, in FIG. 6A, FIG. 6B, and FIG. 6C.

In some embodiments, a parameter type corresponding to at least one dimension of the three-dimensional coordinate system is determined based on the first input from the user. More descriptions of the first input can be found elsewhere in the present disclosure, e.g., FIG. 7A and FIG. 7B.

In some embodiments, the first input includes an operation of the user on a displayed initial stereo graphic, the operation including at least one of zooming or dragging. More descriptions of the operations can be found elsewhere in the present disclosure, e.g., FIG. 7A and FIG. 7B.

In some embodiments, the task management system 900 further includes a task determination module 950, and the task determination module 950 is used to determine the content of the task based on a second input from the user. More descriptions of the task determination module 950 can be found elsewhere in the present disclosure, e.g., the description of the second input in FIG. 3A.

In some embodiments, the task display module 930 is further configured to display at least one replica stereo graphic of the stereo graphic based on the third input from the user, the at least one replica stereo graphic and the stereo graphic having a same parameter value of at least one parameter type. More descriptions of the third input can be found elsewhere in the present disclosure, e.g., the descriptions of the third input in FIG. 8.

It should be understood that the system and its modules shown in FIG. 9 may be implemented using a variety of approaches. It should be noted that the above description of the task management system and its modules is provided only for descriptive convenience, and does not limit the present disclosure to the scope of the embodiments cited. It is to be understood that for a person skilled in the art; after understanding the principle of the system, it may be possible to arbitrarily combine the modules or form a sub-system to connect with other modules without departing from this principle. In some embodiments, the coordinate system display module, the determination module, or the like disclosed in FIG. 9 may be different modules in a system, or a single module realizing the functions of two or more modules described above. For example, the various modules may share a storage module, and the various modules may each have a respective storage module. Changes such as these are within the scope of protection of the present disclosure.

The basic concepts have been described above, and it is apparent to those skilled in the art that the foregoing detailed disclosure serves only as an example and does not constitute a limitation of the present disclosure. While not expressly stated herein, a person skilled in the art may make various modifications, improvements, and amendments to the present disclosure. Those types of modifications, improvements, and amendments are suggested in the present disclosure, so those types of modifications, improvements, and amendments remain within the spirit and scope of the exemplary embodiments of the present disclosure.

Also, the present disclosure uses specific words to describe embodiments of the present disclosure, such as “one embodiment”, “an embodiment”, and/or “some embodiments” means a feature, structure, or characteristic associated with at least one embodiment of the present disclosure. Accordingly, it should be emphasized and noted that two or more references in the present disclosure, at different locations, to “one embodiment” “an embodiment” or “an alternative embodiment” in different places in the present disclosure do not necessarily refer to the same embodiment. In addition, certain features, structures, or characteristics of one or more embodiments of the present disclosure may be suitably combined.

Additionally, unless expressly stated in the claims, the order of the processing elements and sequences, the use of numerical letters, or the use of other names as described in the present disclosure are not intended to qualify the order of the processes and methods of the present disclosure. While some embodiments of the invention that are currently considered useful are discussed in the foregoing disclosure by way of various examples, it is to be understood that such details serve only illustrative purposes and that additional claims are not limited to the disclosed embodiments, rather, the claims are intended to cover all amendments and equivalent combinations that are consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be noted that in order to simplify the presentation of the present disclosure, and thereby aid in the understanding of one or more embodiments of the invention, the foregoing descriptions of embodiments of the present disclosure sometimes combine a variety of features into a single embodiment, accompanying drawings, or descriptions thereof. However, this method of disclosure does not imply that the objects of the present disclosure require more features than those mentioned in the claims. Rather, claimed subject matter may lie in less than all features of a single foregoing disclosed embodiment.

Some embodiments use numbers to describe the number of components, attributes, and it should be understood that such numbers used in the description of the embodiments are modified in some examples by the modifiers “about”, “approximately”, or “substantially”. Unless otherwise noted, the terms “about,” “approximately,” or “substantially” indicate that a ±20% variation in the stated number is allowed. Correspondingly, in some embodiments, the numerical parameters used in the specification and claims are approximations, which can change depending on the desired characteristics of individual embodiments. In some embodiments, the numerical parameters should consider the specified number of valid digits and employ general place-keeping. While the numerical domains and parameters used to confirm the breadth of their ranges in some embodiments of this specification are approximations, in specific embodiments, such values are set to be as precise as possible within a feasible range.

For each of the patents, patent applications, patent application disclosures, and other materials cited in the present disclosure, such as articles, books, specification sheets, publications, documents, etc., the entire contents of which are hereby incorporated herein by reference. Application history documents that are inconsistent with or conflict with the contents of the present disclosure are excluded, as are documents (currently or hereafter appended to the present disclosure) that limit the broadest scope of the claims of the present disclosure. It should be noted that in the event of any inconsistency or conflict between the descriptions, definitions, and/or use of terms in the materials appended to the present disclosure and those set forth herein, the descriptions, definitions, and/or use of terms in the present disclosure shall prevail.

Finally, it should be understood that the embodiments described in the present disclosure are only used to illustrate the principles of the embodiments of the present disclosure. Other deformations may also fall within the scope of the present disclosure. As such, alternative configurations of embodiments of the present disclosure may be viewed as consistent with the teachings of the present disclosure as an example, not as a limitation. Correspondingly, the embodiments of the present disclosure are not limited to the embodiments expressly presented and described herein.

What is claimed is:

1. A task management method, comprising:
displaying a three-dimensional coordinate system, dimensions of the three-dimensional coordinate system corresponding one-to-one to parameter types of a task;
determining or updating parameter values of the task based on a first input from a user, the parameter values corresponding one-to-one to the parameter types, the first input including an operation of the user on a displayed initial stereo graphic, the operation including at least one of zooming or dragging;
displaying the task in the three-dimensional coordinate system through a stereo graphic based on the parameter values of the task, the task referring to a related content that needs to be performed, the task including multiple, the parameter types including at least one of time or resource, parameter information corresponding to different parameter types of the task being displayed in different ways, a position of the stereo graphic in the three-dimensional coordinate system being correlated with the parameter values; and
adjusting the parameter values of the task corresponding to the stereo graphic based on editing of the stereo graphic.

2. The method of claim 1, wherein a transparency of the stereo graphic is related to an importance degree or an execution time of the task corresponding to the stereo graphic.

3. The method of claim 1, wherein a transparency of the stereo graphic is related to an execution time of the task corresponding to the stereo graphic.

4. The method of claim 1, further comprising:
constructing a new coordinate system based on one or two dimensions of the three-dimensional coordinate system; and
displaying the task in the new coordinate system based on parameter values of the task in the one or two dimensions.

5. The method of claim 4, the displaying of the task in the new coordinate system is in a form of a projection of the stereo graphic corresponding to the task along one of directions in the three-dimensional coordinate system.

6. The method of claim 1, further comprising:
determining a parameter type corresponding to at least one dimension of the three-dimensional coordinate system based on the first input from the user.

7. The method of claim 1, wherein an initial position of the initial stereo graphic in the three-dimensional coordinate system is determined through prediction based on relevant information of the user.

8. The method of claim 7, wherein the prediction is performed by a prediction model, the prediction model being a machine learning model.

9. The method of claim 7, wherein the relevant information of the user including at least one of identity information of the user or setting information of a historical task of the user.

10. The method of claim 1, further comprising:
determining content of the task based on a second input from the user.

11. The method of claim 10, further comprising:
in response to a first triggering operation from the user, displaying the content of the task within a predetermined range associated with the stereo graphic.

12. The method of claim 1, further comprising:
displaying at least one replica stereo graphic of the stereo graphic based on a third input from the user, wherein the at least one replica stereo graphic and the stereo graphic have a same parameter value of at least one parameter type.

13. The method of claim 1, wherein each dimension of the three-dimensional coordinate system includes coordinate scale values.

14. The method of claim 1, further comprising:
determining a transparency of the stereo graphic based on the position of the stereo graphic in the three-dimensional coordinate system.

15. The method of claim 1, further comprising:
deforming the three-dimensional coordinate system and the stereo graphic based on a fourth input from the user, the deforming including at least one of scaling or rotation.

16. The method of claim 15, wherein an input manner of the user includes hand gesture input.

17. The method of claim 1, further comprising:
determining a categorization of the task; and
displaying labeling information of the stereo graphic based on the categorization of the task.

18. The method of claim 17, wherein the categorization of the task is determined based on at least one of an occurrence frequency or an importance degree of the task.

19. A task management system, comprising:
a coordinate system display module configured to display a three-dimensional coordinate system, dimensions of the three-dimensional coordinate system corresponding one-to-one to parameter types of a task;
a determination module configured to determine or update parameter values of the task based on a first input from a user, the parameter values corresponding one-to-one to the parameter types; and
a task display module configured to display the task in the three-dimensional coordinate system through a stereo graphic based on the parameter values of the task, a position of the stereo graphic in the three-dimensional coordinate system being correlated with the parameter values.

20. A task management device, comprising at least one processor and at least one memory, wherein the at least one memory is configured to store computer instructions, and the at least one processor is configured to execute at least a portion of the computer instructions to implement a task management method of claim 1.
